(19) United States
(12) Patent Application Publication
(10) Pub. No.: US 2026/0128791 A1
(43) Pub. Date: May 7, 2026

(54) System for free space optical communication using active beam steering

(71) Applicant: SIGNIFY HOLDING B.V., EINDHOVEN (NL)

(72) Inventor: JORIS JAN VREHEN, WAALRE (NL)

(21) Appl. No.: 19/118,801

(22) PCT Filed: Oct. 16, 2023
(86) PCT No.: PCT/EP2023/078614

§ 371 Date: Apr. 7, 2025

(30) Foreign Application Priority Data
Oct. 21, 2022 (EP) 22202874.8

(51) Int. Cl. H04B 10/11; G02B 5/12; H04B 10/60

(52) U.S. Cl. CPC H04B 10/11; G02B 5/12; H04B 10/60

(57) ABSTRACT

Optical receiver (2) comprising a semitransparent retroreflector (1; 100; 101; 102; 103; 104) configured to assist in a retroreflector based beam alignment procedure for the optical receiver (2). A photodetector (12) of the receiver is placed behind the retroreflector. The semitransparent retroreflector (1; 101; 102) comprises a coating (5) applied to an optical component of the optical receiver (2), or the semitransparent retroreflector (100; 103; 104) comprises an optical material introduced by replacing at least a part of an original optical material of an optical component of the optical receiver (2). Optical wireless communication system comprising the optical receiver.

### FIELD OF THE INVENTION

The present invention generally relates to a system for free space optical communication using active beam steering. More particularly, the present invention relates to a semitransparent retroreflector configured to assist a retroreflector based beam alignment in an optical wireless communication, OWC, system, the OWC system comprising an optical receiver, the optical receiver comprising one or more optical components.

### BACKGROUND OF THE INVENTION

This invention is generally employed in Li-Fi communication applications and in particular to Li-Fi communication applications with active beam steering. Li-Fi is a wireless communication technology which utilizes light to transmit data between devices. Li-Fi communication systems are light communication systems capable of transmitting data at high speeds over the visible light, ultraviolet, and infrared spectrums. Li-Fi communication systems use light from light-emitting diodes (LEDs) as a medium to deliver network, mobile, high-speed communication in a similar manner to Wi-Fi.

With the increase of required data rates and increasing distances more and more power is needed in the optical beam that carries the data. A way to lower the needed power is to reduce the beam width of the beam (illuminating a smaller area). A drawback of a narrow beam is that the beam needs to be aimed accurately in the direction of the opposite receiver. This can be done manually, or automatically. For an automatic alignment of the beam a signal is needed to establish in which direction the beam should be moved.

One well known method to aim the beam at a target is by placing a retroreflector at the position of the target. By scanning the beam one can find the position of the retroreflector by looking at the reflected light returning to the beam steering device. To keep track of the position of the retroreflector, small variations can be made in the beam direction resulting in a modulation of the returned signal strength. The small variation in beam direction can have different shapes. If the same beam is also used to transfer data to the target, a photo detector must be placed near the retroreflector such that the data receiving receiver is also illuminated when the beam is aimed at the retroreflector. For this one can use a retroreflective foil with a hole in the center where the data receiver can be placed.

U.S. Pat. No. 11,177,879 B2 discloses a system and method for performing free space optical communication with a plurality of streetlamp assemblies. The method includes transmitting a light beam from a first free space optical (FSO) unit of a first streetlamp assembly to a second FSO unit of a second streetlamp assembly along a transmission path. A transmission error is detected while transmitting the light beam along the transmission path. A location of one or more smart mirrors is obtained. An alternate transmission path is determined from the first FSO unit to the second FSO unit or a third FSO unit. The alternate transmission path includes a reflection of the light beam from the one or more smart mirrors. The smart mirrors may be semi-transparent. The shape of the reflective surface of the smart mirror may be curved.

WO2017098220A1 relates to a system for remotely sensing light emanating from within a monitored environment. The system comprises one or more retro-reflective optical elements bearing a reflective optical coating upon a surface and position within the environment to be monitored.

US2018128951A1 relates to a device for a sending and receiving unit of a communication arrangement. D3 also fails to disclose a retroreflector based beam alignment system, with the photodetector placed behind the semitransparent retroreflectors for optical data communication.

However, a problem related to the above described retroreflectors and data receiver solutions is that they are rather large. This has the consequence that a wider light beam is needed to illuminate both the receiver and the retro reflector.

### SUMMARY OF THE INVENTION

It is an object of the present invention to overcome this problem, and to provide a semitransparent retroreflector configured to assist a retroreflector based beam alignment in an optical wireless communication, OWC, system, which retroreflector is compact and with which a narrower light beam as compared to the prior art solutions is needed to illuminate both the receiver and the retroreflector.

It is a further object of the present invention to provide such a semitransparent retroreflector with which smaller amounts of power is needed for data transmission in the OWC system and which is cost-effective to implement.

According to a first aspect of the invention, this and other objects are achieved by means of an optical receiver comprising a semitransparent retroreflector configured to assist a retroreflector based beam alignment procedure for the optical receiver; a photodetector configured to detect optical beams for optical wireless communication; wherein the photodetector is placed behind the semitransparent retroreflector; and an optical component; where the semitransparent retroreflector comprises a coating applied to the optical component, or wherein the semitransparent retroreflector comprises an optical material being at least a part of the optical component.

Thereby, an in particular by providing either that the semitransparent retroreflector comprises a coating applied to an optical component of the optical receiver, or that the semitransparent retroreflector comprises an optical material introduced by replacing at least a part of an original optical material of an optical component of the optical receiver, a semitransparent retroreflector which is configured to assist a retroreflector based beam alignment in an optical wireless communication, OWC, system, which is very compact and with which a narrower light beam as compared to the prior art solutions is needed to illuminate both the receiver and the retroreflector is provided for.

It is noted that in the case that the semitransparent retroreflector comprises an optical material introduced by replacing at least a part of an original optical material of an optical component of the optical receiver, the part replaced may in principle be any part, but is preferably a part of a surface of the optical component in question which surface, when the semitransparent retroreflector is mounted in a use position, is intended for facing a light source.

Such a semitransparent retroreflector further requires a small amount of power for data transmission in an OWC system and is cost-effective to implement.

The coating may comprise a thickness configured to allow a part of a light beam emitted by a light source to be transmitted through the coating and a part of the light beam emitted by the light source to be reflected by the coating.

Thereby, the coating provides the semitransparent retroreflector with the appropriate semitransparent properties. Especially for metal coatings, the amount of light transmitted through the coating versus the amount of light reflected by the coating may be controlled by adjusting the thickness of the coating, since a thicker coating will increase reflection and reduce transmission.

The coating may comprise a thickness configured to allow at least 50% or at least 70% of the light of a light beam emitted by a light source of the OWC-system to be transmitted through the coating and to allow at most 50% or at most 30% of the light of a light beam emitted by the light source of the OWC-system to be reflected by the coating.

The 50% or more, or 70% or more, of the light being transmitted are used for the signal detection in the OWC-system. The 50% or less, or 30% or less, of the light being reflected ensures a proper retroreflector function of the semitransparent retroreflector. Thereby it becomes possible to control the reflection and transmission as a function of the wavelength of the light. Specially in case of metallic coatings also absorption may play a role.

The coating may be a metal, such as gold.

Thereby, a simple and easy to apply coating is provided for. If such a coating is made sufficiently thin, the coating becomes semitransparent such as to ensure a proper retroreflector function of the semitransparent retroreflector. In this connection “sufficiently thin” may be understood as comprising a thickness suitable for obtaining any of the above requirements for light of a light beam emitted by a light source, or as comprising a thickness of 2 μm or less, such as between 1 nm and 2 μm. It is also understood that a suitable thickness for a coating layer to be rendered semitransparent for light of a light beam emitted by a light source may depend on factors such as the wavelength of the said light and the specific type of material used for the coating.

The coating may comprise a stack of layers of a dielectric material.

Thereby the coating may be provided in a simple and easy to produce manner. For a dielectric coating the amount of light reflected versus the amount of light transmitted is dependent on the stack design, which is a function of the materials used, thicknesses of the individual layers and the number of layers.

The coating may comprise or may be provided on a curved surface.

The semitransparent retroreflector may comprise a lens, and the curved surface may comprise a curvature corresponding to the curvature of a focal plane of the lens.

By providing such a curved surface, and especially if the curved surface is further placed in the focal point of the lens, the light reflected by the semitransparent retroreflector is sent back towards a beam steering device following the same or nearly the same optical path as the incident light. By placing such a semitransparent retroreflector at the position of the target, aiming a beam at the semitransparent retroreflector, and scanning the beam, the position of the semitransparent retroreflector may be determined with a high degree of precision by looking at the light returning to the beam steering device.

The semitransparent retroreflector may comprise a lens and an optical substrate, where the coating is applied to the optical substrate such as to render the optical substrate semitransparent, and where the optical substrate is placed in the focal point of the lens, or where the optical substrate is placed in a distance from the focal point of the lens being smaller than 5 mm or 2 mm or 1 mm. The optimum distance between the focal point of the lens and the optical substrate depends on the focal length and diameter of the lens used in the specific semitransparent retroreflector. The distance of the optical substrate to the focal point of the lens may be determined as function of the focal length of the lens, the lens diameter and the maximum reflected beam angle.

The semitransparent retroreflector may comprise a lens and an optical substrate, where the coating is applied to the optical substrate such as to render the optical substrate semitransparent, and where the optical substrate is placed in a distance D from the focal point of the lens, the distance D being in between

$$\frac{{f}^{2}}{\frac{- d}{0.176} - 2 f} < D < \frac{{f}^{2}}{\frac{d}{0.176} - 2 f}$$

where f is the focal length of the lens and d is the diameter of the lens. By fulfilling this relation for the distance D, the reflected beam angle is limited to 20° full width at half maximum (FWHM).

Thereby, the lens and the optical substrate forms the retroreflector. By applying the coating to the optical substrate, the retroreflector is made semitransparent. Part of the light incident on the optical substrate is thus transmitted through to the optical receiver (for instance a photodiode), thereby effectively co-locating the retroreflector and the photo diode. This will allow for a much smaller and more compact retroreflector, which in turn leads to lower power needed for the data transmission.

By placing the optical substrate in a distance D from the focal point of the lens fulfilling the above relation or being smaller than 5 mm or 2 mm or 1 mm, and thus slightly out of focus, a convergence of a diverging reflected beam is obtained such that a larger spot is returned to the beam steering unit.

The optical substrate may comprise a curved surface, on which the coating is applied, the curved surface comprising a curvature corresponding to the curvature of a focal plane of the lens.

Thereby, and especially if the optical substrate is placed in the focal point of the lens, the light reflected by the optical substrate is sent back towards the beam steering device of an OWC-system following the same or nearly the same optical path as the incident light. By placing such a semitransparent retroreflector at the position of the target, aiming a beam at the semitransparent retroreflector, and scanning the beam, the position of the semitransparent retroreflector may be determined with a high degree of precision by looking at the light returning to the beam steering device.

The coating may be applied directly onto the optical component of the optical receiver.

Thereby, a semitransparent retroreflector with a particularly compact structure is obtained.

The optical material introduced by replacing at least a part of the original optical material of an optical component of an optical receiver may comprise a Fresnel reflectivity of between 3% and 5%, or of 4%.

Such a Fresnel reflectivity may be obtained by using the inherent Fresnel reflectivity of a suitable optical medium. This in turn provides for a semitransparent retroreflector with a particularly simple and compact structure. It is noted that the above stated values are reasonable values for glass air transition. Higher values may be applicable if high index materials, such as a Si Photo detector, are used.

The optical material introduced by replacing at least a part of the original optical material of the optical component of the optical receiver may be introduced by providing a layer of the optical material on the optical component of the optical receiver.

Thereby, a semitransparent retroreflector with a particularly compact structure is provided for.

The optical material introduced by replacing at least a part of the original optical material of the optical component of an optical receiver may be provided with or on a curved surface.

The semitransparent retroreflector may comprise a lens, and the curved surface may comprise a curvature corresponding to the curvature of a focal plane of the lens.

This curvature may for instance be molded in the optical component of the optical receiver, such as in a photodiode package. Thereby, a very cost-effective implementation of such a curvature becomes possible.

The optical component of the optical receiver, to which the optical material is introduced by replacing at least a part of the original optical material of the optical component, may be any one of a cover glass, a part of a housing and a part of a surface of a photodetector or photodiode.

Thereby, a semitransparent retroreflector with a particularly simple and compact structure is provided for, especially since it is not needed to add material to the system.

The coating may further comprise a high reflectivity, such as a reflectivity of more than 80%, 90% or 95%, for light having a wavelength differing from the wavelength or wavelengths of a light beam emitted by a light source.

Thereby the disturbance from other light sources of other wavelengths that that or those of a light beam emitted by a light source is minimized or even eliminated altogether.

The invention also relates to an optical wireless communication, OWC, system, comprising an optical receiver according to the present invention.

The OWC system may comprise an optical receiver and at least one light source, and the optical receiver may be placed downstream of the semitransparent retroreflector seen in the direction of propagation of light emitted by the at least one light source.

The semitransparent retroreflector of the OWC system may comprise an optical material introduced by replacing the original optical material of an optical component of an optical receiver of the OWC-system, and the optical component may be any one of: at least a part of a photodiode, at least a part of a surface of a photodetector, at least a part of a cover glass of the optical receiver, and at least a part of a housing of the optical receiver. The optical receiver of the OWC-system may be placed in the focal point of a lens of the semitransparent retroreflector.

Thereby, the inherent reflectivity if the optical receiver and, where provided, a coating of the optical receiver, may be exploited to provide the desired semitransparent retroreflector.

It is noted that the invention relates to all possible combinations of features recited in the claims.

Beneficially, the present invention also relates to a method for manufacturing a semitransparent retroreflector for an optical receiver according to the present invention; the method comprising:
replacing at least a part of an original optical material of the optical component of the optical receiver with another optical material to allow a part of a light beam hit on the semitransparent retroreflector to be transmitted through and a part of the light beam to be reflected.

### BRIEF DESCRIPTION OF THE DRAWINGS

This and other aspects of the present invention will now be described in more detail, with reference to the appended drawings showing embodiment(s) of the invention.

FIG. 1 shows a schematic side view of an optical wireless communication, OWC, system comprising a semitransparent retroreflector according to the invention.

FIG. 2 shows a schematic side view of a variation of a semitransparent retroreflector according to FIG. 1.

FIG. 3 shows a schematic side view of an optical wireless communication, OWC, system comprising another semitransparent retroreflector according to the invention.

FIG. 4 shows a schematic side view of a variation of a semitransparent retroreflector according to FIG. 3.

FIG. 5 shows a schematic side view of another semitransparent retroreflector according to the invention.

FIG. 6 shows a schematic side view of a variation of a semitransparent retroreflector according to FIG. 5.

FIG. 7 shows a schematic side view of another semitransparent retroreflector according to the invention.

FIG. 8 shows a schematic side view of a variation of a semitransparent retroreflector according to FIG. 7.

As illustrated in the figures, the sizes of layers and regions are exaggerated for illustrative purposes and, thus, are provided to illustrate the general structures of embodiments of the present invention. Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

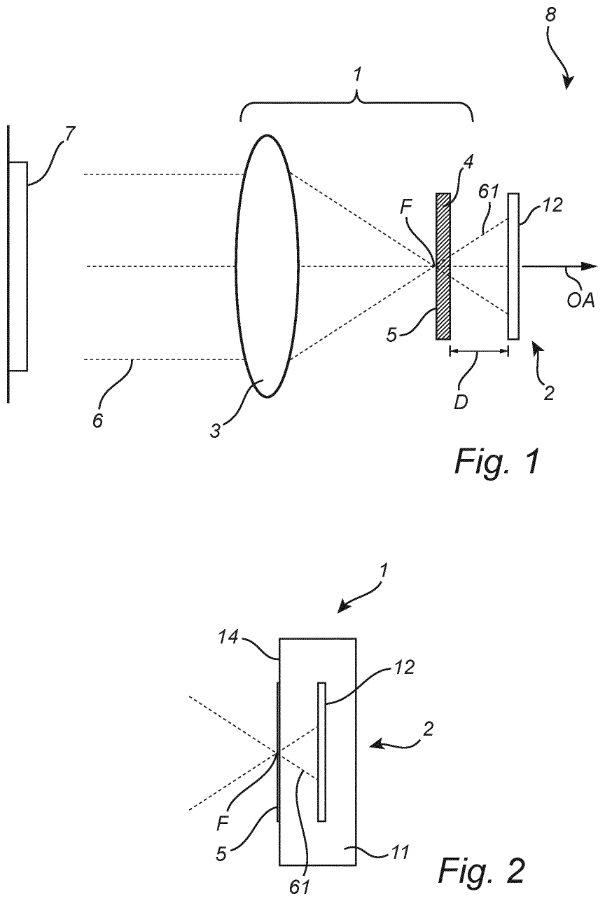

FIG. 1 shows a schematic side view of an optical wireless communication, OWC, system 8 comprising a semitransparent retroreflector 1 according to the invention. The semitransparent retroreflector 1 according to the invention is configured to assist in a retroreflector based beam alignment procedure in n OWC system 8. Thus, semitransparent retroreflector 1 according to the invention may form part of an OWC system 8. The OWC system further comprises a light source 7 and an optical receiver 2. In the figures, OA denotes the optical axis of both the OWC system 8 and the semitransparent retroreflector 1.

The light source 7 is a laser light source such as a LED, a laser or a semiconductor laser. The light source 7 is configured to, in operation, emit laser light 6, particularly highly collimated laser light 6. In FIG. 1, one light source 7 is shown. It is also feasible to provide a OWC system 8 with more than one light source 7 such as an array of light sources 7.

The optical receiver 2 may be any type of optical receiver suitable for use in a OWC system. The optical receiver 2 shown in FIG. 1 is for example a photodetector 12. The optical receiver 2 may also be a photodiode, which may comprise a photodetector 12. The optical receiver 2 in any event comprises one or more optical components. The optical components may include one or more of the photodetector 12 itself, a lens 3, an optical substrate 4, a cover glass 9 and an envelope 11.

The semitransparent retroreflector 1 is generally and irrespective of the embodiment configured to assist a retroreflector based beam alignment in an OWC system 8.

The semitransparent retroreflector 1 may as shown in FIG. 1 comprise a coating 5 applied to an optical component of the optical receiver 2 of the OWC-system 8. Alternatively, the semitransparent retroreflector 1 may as shown in FIG. 2 comprise an optical material 4 introduced by replacing at least a part of the original optical material of an optical component of the optical receiver 2 of the OWC-system 8.

As is shown in FIG. 1, the semitransparent retroreflector 1 comprises a lens 3 and an optical substrate 4. The optical substrate 4 is placed in the focal point F of the lens 3 thereby creating a retroreflector. The coating 5 is applied to the optical substrate 4 and is configured to render or make the optical substrate 4 semi-transparent, thereby creating a semitransparent retroreflector 1. Essentially, the optical substrate 4 and the coating 5 together form a semitransparent mirror. Thereby, part of the light 6 emitted by the light source 7 is transmitted through (cf. beam 61) to the optical receiver 2. In this way, the semitransparent retroreflector 1 and the optical receiver 2 are effectively co-located such that the optical components of the retroreflector 1, that is the lens 3 and the optical substrate 4, may likewise be considered optical components of the optical receiver 2. The optical substrate 4, and thereby the coating 5, is furthermore placed in a distance D from the optical receiver 2.

The optical receiver 2, and particularly the photodetector 12, is generally, and irrespective of the embodiment, arranged downstream of the semitransparent retroreflector 1, and especially of the optical substrate 4 and coating 5 as seen in the direction of propagation of the light 6 and/or along the optical axis OA. Thereby, the optical receiver 2 is arranged to capture the light 61 that is transmitted through the semitransparent retroreflector 1.

Irrespective of the embodiment, the coating 5 may comprise a thickness configured to allow a part 61 of a light beam 6 emitted by a light source 7 of the OWC-system 8 to be transmitted through the coating 5 and a part of the light beam 6 emitted by the light source 7 of the OWC-system 8 to be reflected by the coating 5. The coating may comprise a thickness configured to allow 50%, 60% or 70% of the light of a light beam 6 emitted by a light source 7 of the OWC-system 8 to be transmitted through the coating 5 and to allow 50% or 40% or 30% of the light of a light beam 6 emitted by the light source 7 of the OWC-system 8 to be reflected by the coating 5. The coating 5 may comprise a thickness being between 1 nm and 2 μm. The coating 5 may further comprise a high reflectivity for light having a wavelength differing from the wavelength or wavelengths of a light beam 6 emitted by a light source 7 of the OWC-system 8. The coating 5 may be a metal, such as gold. Alternatively, the coating 5 may comprise a stack of layers of a dielectric material.

In the variant shown in FIG. 2, the semitransparent retroreflector 1 likewise comprises a coating 5 and a lens 3. The lens 3 is for simplicity not shown in FIG. 2. The coating 5 is here placed directly on the optical receiver 2. Thus, the distance D is in this case zero. The optical receiver 2 comprises a photodetector 12 and an encapsulation 11 encapsulating the photodetector 12. The encapsulation 11 may be a plastic or an epoxy resin molded over the photodetector 12. As shown in FIG. 2, the encapsulation 11 comprises a flat surface 14.

More particularly, the coating 5 is placed on or at the surface 14, or replacing a part of the surface 14, of the encapsulation 11 facing the lens 3 in the assembled condition of the semitransparent retroreflector 1. The coating 5 may simply be added to the surface 14. The coating 5 may be introduced as an optical material replacing a part of the original optical material of an optical component in form of the encapsulation 11 of the optical receiver 2 of the OWC-system 8. The coating 5 is again placed in the focal point F of the lens 3 thereby creating a retroreflector. The retroreflector is rendered a semitransparent retroreflector 1 by exploiting the inherent reflectivity (Fresnel reflectivity) of the photodetector 12. In this case the optical substrate 4 may therefore be omitted.

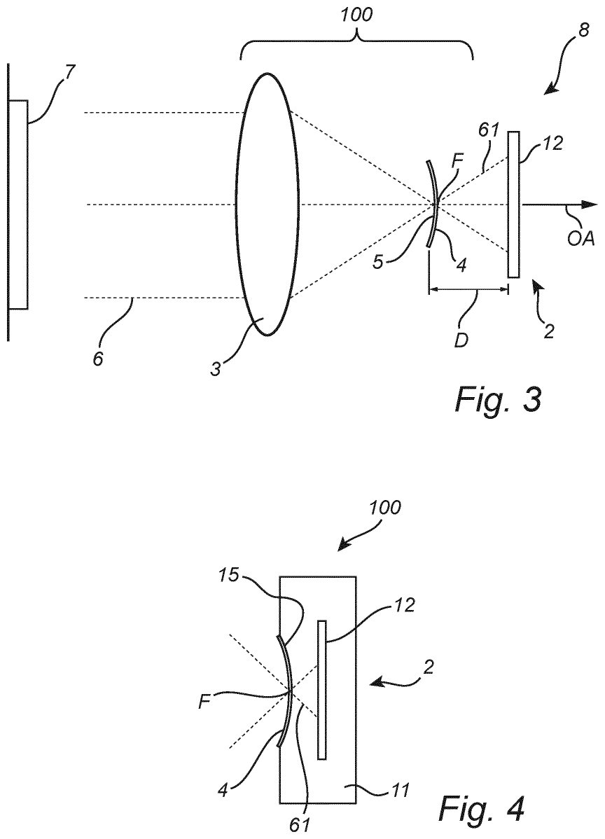

Turning now to FIGS. 3 and 4, perspective side views of two variants of a semitransparent retroreflector 100 are shown.

The variant of the semitransparent retroreflector 100 shown in FIG. 3 differs from the semitransparent retroreflector 1 described above with reference to FIG. 1 generally in that the optical substrate 4 is a curved optical substrate 4. A coating 5 is applied to the curved optical substrate 4 and is configured to render or make the curved optical substrate 4 semi-transparent, thereby creating a semitransparent retroreflector 100. Generally, and irrespective of the embodiment, the curved optical substrate 4 may be provided with a surface having a curvature corresponding to the curved focal plane of the lens 3.

The variant of the semitransparent retroreflector 100 shown in FIG. 4 differs from the semitransparent retroreflector 1 described above with reference to FIG. 2 generally in that the optical substrate 4 is a curved optical substrate 4 and that the mirror is provided on or in or recessed in a curved surface 15 provided in the encapsulation 11 of the optical detector 2.

In the above variants of a semitransparent retroreflector 1 or 100, the optical substrate 4 or coating 5, as the case may be, is in all cases placed in the focal point F of the lens 3. Another option is to place the optical substrate 4 or coating 5, as the case may be, slightly out of focus, that is displaced slightly from the focal point F of the lens 3. This would lead to a slightly converging or diverging reflected beam such that a larger spot is returned to the beam steering unit. In this connection, displaced slightly from the focal point F of the lens 3 may be understood as meaning placed in a distance D from the focal point F of the lens 3 being smaller than 5 mm or 2 mm or 1 mm. Displaced slightly from the focal point F of the lens 3 may also, and more generally, be understood as meaning placed in a distance a distance D from the focal point of the lens 3, the distance D being in between

$$\frac{{f}^{2}}{\frac{- d}{0.176} - 2 f} < D < \frac{{f}^{2}}{\frac{d}{0.176} - 2 f}$$

where f is the focal length of the lens and d is the diameter of the lens 3. By fulfilling this relation for the distance D, the reflected beam angle is limited to 20° full width at half maximum (FWHM).

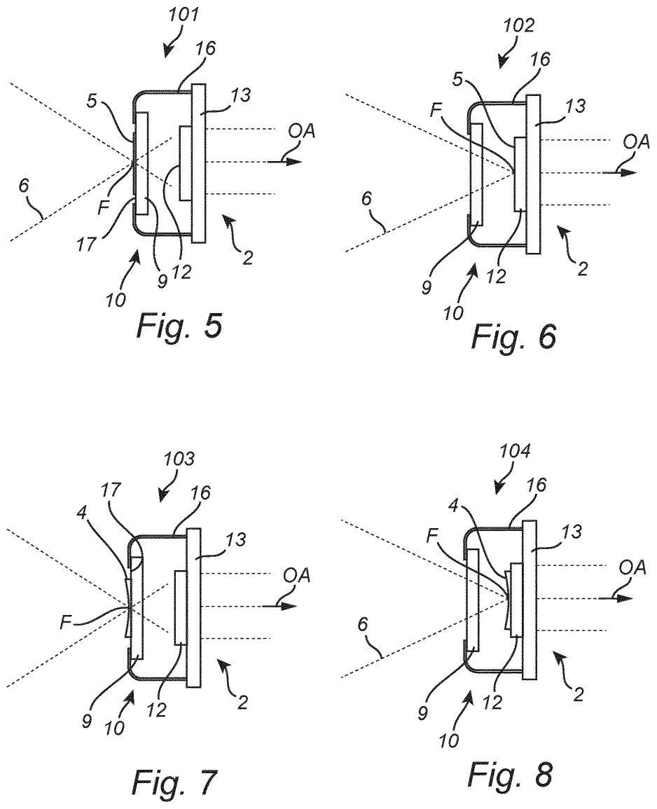

Turning now to FIG. 5, a schematic side view of another semitransparent retroreflector 101 according to the invention is shown. The semitransparent retroreflector 101 shown in FIG. 5 differs from the semitransparent retroreflectors described above with reference to FIGS. 1-4 in virtue of the following features.

The optical receiver 2 is a photodiode comprising a photodetector 12 arranged in a housing 10. The housing comprises a bottom 13, on which the photodetector 12 is arranged, a wall 16 extending from the bottom 13 such as to enclose the photodetector 12, and a cover glass 9 arranged in a front surface of the wall 16 opposite to the bottom 13.

A coating 5 is applied to a surface 17 of the cover glass 9, such that the lens 3 (not shown for simplicity) and the cover glass 9 with the coating 5 together form the semitransparent retroreflector 101. The coating is placed in the focal point F of the lens 3.

FIG. 6 shows a schematic side view of another semitransparent retroreflector 102 according to the invention. The semitransparent retroreflector 103 shown in FIG. 6 differs from the semitransparent retroreflector 101 described above with reference to FIG. 5 in virtue of the following features.

A coating 5 is now applied directly onto the photodetector 12. The photodetector 12 is placed in the focal point F of the lens 3, particularly with the coating 5 placed in the focal point F of the lens 3. Thereby, the inherent reflectivity (Fresnel reflectivity) of the photodetector 12 is exploited to render the semitransparent retroreflector 103 semitransparent. If a coating 5 is applied, this coating 5 determines the amount of light that is reflected. If no coating 5 is applied the inherent Fresnel reflection of surface of the photodetector 12, particularly being a Si-surface, can be used to determine the amount of light reflected.

FIG. 7 shows a schematic side view of another semitransparent retroreflector 103 according to the invention. The semitransparent retroreflector 103 shown in FIG. 7 differs from the semitransparent retroreflectors 101 and 102 described above with reference to FIGS. 5 and 6 in virtue of the following features.

An optical substrate 4 with a curved surface is arranged on a surface 17 of the cover glass 9, such that the lens 3 (not shown for simplicity) and the cover glass 9 with the optical substrate 4 together form the semitransparent retroreflector 102. The optical substrate 4 is placed in the focal point F of the lens 3, particularly with the curved surface placed in the focal point F of the lens 3. Alternatively, the optical substrate 4 with the curved surface may also be arranged in, such as recessed in, the surface 17 of the cover glass 9.

FIG. 8 shows a schematic side view of another semitransparent retroreflector 104 according to the invention. The semitransparent retroreflector 104 shown in FIG. 8 differs from the semitransparent retroreflector 103 described above with reference to FIG. 7 in virtue of the following features.

An optical substrate 4 with a curved surface is now arranged directly on the photodetector 12. The photodetector 12 is placed in the focal point F of the lens 3, particularly with the optical substrate 4 placed in the focal point F of the lens 3. Thereby, the inherent reflectivity (Fresnel reflectivity) of the photodetector 12 is exploited to render the semitransparent retroreflector 104 semitransparent. Alternatively, the optical substrate 4 with the curved surface may also be arranged directly on an encapsulation, in an encapsulation or recessed in an encapsulation of the photodetector 12.

The person skilled in the art realizes that the present invention by no means is limited to the preferred embodiments described above. On the contrary, many modifications and variations are possible within the scope of the appended claims.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. An optical receiver comprising:
a semitransparent retroreflector configured to assist a retroreflector based beam alignment procedure for the optical receiver;
a photodetector configured to detect optical beams for optical wireless communication; wherein the photodetector is placed behind the semitransparent retroreflector; and
an optical component;
wherein the semitransparent retroreflector comprises a coating applied to the optical component, or
wherein the semitransparent retroreflector comprises an optical material being at least a part of the optical component.

2. The optical receiver according to claim 1, wherein the coating comprises a thickness configured to allow a part of a light beam emitted by a light source to be transmitted through the coating and a part of the light beam emitted by the light source to be reflected by the coating, or
wherein the coating comprises a thickness configured to allow at least 50% or at least 70% of the light of a light beam emitted by a light source to be transmitted through the coating and to allow at most 50% or at most 30% of the light of a light beam emitted by the light source to be reflected by the coating.

3. The optical receiver according to claim 1, wherein the coating is a metal, such as gold, or wherein the coating further comprises a stack of layers of a dielectric material.

4. The optical receiver according to claim 1, wherein the coating comprises or is provided on a curved surface.

5. The optical receiver according to claim 4, wherein the semitransparent retroreflector comprises a lens, and wherein the curved surface comprises a curvature corresponding to the curvature of a focal plane of the lens.

6. The optical receiver according to claim 1, wherein the semitransparent retroreflector comprises a lens and an optical substrate, wherein the coating is applied to the optical substrate, and wherein:
the optical substrate is placed in the focal point (F) of the lens, or
the optical substrate is placed in a distance from the focal point (F) of the lens being smaller than 5 mm or 2 mm or 1 mm.

7. The optical receiver according to claim 1, wherein the coating is applied directly onto the optical component of the optical receiver.

8. The optical receiver according to claim 1, wherein the optical material being at least a part of the optical component comprises a Fresnel reflectivity of between 3% and 5%, or of 4%.

9. The optical receiver according to claim 1, wherein the optical material being at least a part of the optical component is introduced by providing a layer of the optical material on the optical component.

10. The optical receiver according to claim 1, wherein the optical material introduced by replacing at least a part of the original optical material of the optical component is provided with or on a curved surface.

11. The optical receiver according to claim 10, wherein the semitransparent retroreflector comprises a lens, and wherein the curved surface comprises a curvature corresponding to the curvature of a focal plane of the lens.

12. The optical receiver according to claim 1, wherein the optical component being at least a part of is any one of a cover glass, a part of a housing and a part of a surface of the photodetector.

13. The optical receiver according to claim 1, wherein the semitransparent retroreflector further comprises an optical material being at least part of the optical component, and wherein the optical component is any one of:
at least a part of the photodetector,
at least a part of a surface of the photodetector,
at least a part of a cover glass of the optical receiver, and
at least a part of a housing of the optical receiver.

14. The optical receiver according to claim 1, wherein the photodetector is placed in the focal point (F) of a lens of the semitransparent retroreflector.

15. An optical wireless communication, OWC, system, comprising an optical receiver according to claim 1.
